(19) United States
(12) Patent Application Publication
(10) Pub. No.: US 2006/0168308 A1
(43) Pub. Date: Jul. 27, 2006

(54) Selective suspension of real time data exchanges for unreliable network connections

(75) Inventors: Joseph Celi, Boca Raton, FL (US); Charles W. Cross, Wellington, FL (US); Brett J. Gavagni, Coconut Creek, FL (US); Peter J. Guasti, Coral Springs, FL (US); Peeyush Jaiswal, Boca Raton, FL (US)

Correspondence Address: Steven M. Greenberg, Esquire;Christopher & Weisberg, P.A., Suite 2040, 200 East Las Olas Boulevard, Fort Lauderdale, FL, 33301, US

(73) Assignee: International Business Machines Corporation, Armonk, NY (US)

(21) Appl. No.: 10/999,413

(22) Filed: Nov. 30, 2004

(51) Int. Cl. G06F 15/16

(52) U.S. Cl. 709/232

(57) ABSTRACT

A method, system and apparatus for the selective suspension of real time data exchanges for unreliable network connections. A selective real time data exchange suspension method can include detecting a network outage condition affecting a real time data exchange. As an example, the real time data exchange can be an exchange of speech data provided by a real time speech server over a data communications network. Subsequently, the real time data exchange can be selectively suspended but not terminated. Finally, the real time data exchange can resume when the network outage condition has been alleviated.

### BACKGROUND OF THE INVENTION

1. Statement of the Technical Field

The present invention relates to the transmission of real time data over a computer communications network and more particularly to managing unreliable connections when transferring real time data over a computer communications network.

2. Description of the Related Art

The advent of the modern computer communications network has revolutionized the manner in which data is exchanged and the speed at which data is exchanged. At the outset of the modern computing era, only the most basic of information could be exchanged between computing devices due to the limitations of network bandwidth and the perceived unreliability of the underlying data exchange media. Today, however, substantial advances in the underlying infrastructure of global computer networks permit the exchange of a wide variety of data ranging from simple text messages to full motion video and telephony.

The exchange of real time data such as speech involves specific considerations not applicable to the exchange of other types of time insensitive data. In this regard, while the slight delay in the arrival of packets in a text message can be inconsequential in respect to the accurate and efficient delivery of the text message, slight delays in the delivery of real time data such as speech can render the ultimately delivered data unusable for its intended purpose. To account for the time sensitivity of real time data, several real time delivery technologies have been proposed to manage the transport and delivery of real time data. The Real Time Protocol (RTP) represents one example of a real time delivery technology.

RTP is a thin protocol providing support for applications with real-time properties, including timing reconstruction, loss detection, security and content identification. Specifically, RTP provides end-to-end delivery services for data with real-time characteristics, such as interactive audio and video. Those services include payload type identification, sequence numbering, time-stamping and delivery monitoring. Applications typically run RTP on top of the universal datagram protocol (UDP) to make use of its multiplexing and checksum services. In that case, both protocols contribute parts of the transport protocol functionality.

RTP can include a control protocol referred to as the real time control protocol (RTCP). RTCP is based on the periodic transmission of control packets to all participants in the session, using the same distribution mechanism as the data packets. The underlying protocol must provide multiplexing of the data and control packets, for example using separate port numbers with UDP. RTCP several functions, the primary function of which is to provide feedback on the quality of the data distribution. This is an integral part of the RTP's role as a transport protocol and is related to the flow and congestion control functions of other transport protocols.

Notably, RTCP can be used to monitor network conditions so that both sender and receiver can make adjustments to their respective systems to adapt to network conditions. In particular, U.S. Pat. No. 6,643,496 to Shimoyama et al. teaches the adjustment of the packet transmission rate of real time data using RTP over RTCP where a target transmission rate cannot be achieved, or where it is judged that packet loss has occurred. Nevertheless, the primary thrust of the Shimoyama patent is to ensure a highest quality of service for real time data over a healthy communicative link.

Importantly, a healthy communicative link cannot always be guaranteed in real time communications. In particular, where real time data such as speech must be exchanged over a wireless medium, a complete loss of the communicative link remains a possibility and can be a frequent occurrence for many. In the case of a complete loss of a communicative link, adjusting the rate of packet transmission to a faster or slower rate cannot suffice. Rather, when the communicative link has become completely lost, the exchange of real time data can be cancelled once a time out condition has been reached. For real time speech data, the complete cancellation of the exchange of real time data is an unacceptable result.

### SUMMARY OF THE INVENTION

The present invention addresses the deficiencies of the art in respect to managing an exchange of real time data in view of failed communicative linkage and provides a novel and non-obvious method, system and apparatus for the selective suspension of real time data exchanges in light of unreliable network connections. In a first aspect of the present invention, a selective real time data exchange suspension method can include detecting a network outage condition affecting a real time data exchange. As an example, the real time data exchange can be an exchange of speech data provided by a real time speech server over a data communications network. Subsequently, the real time data exchange can be selectively suspended but not terminated. Finally, the real time data exchange can resume when the network outage condition has been alleviated.

The detecting step can include the step of detecting a loss of a communicative linkage with a real time data server supporting the real time data exchange. Additionally, the detecting step can include the step of detecting a severe deterioration in link quality of a communicative linkage with a real time data server supporting the real time data exchange. In either case, the detecting step can include monitoring a communicative linkage over which the real time data exchange occurs, observing a network outage in the communicative linkage, and alerting a real time streaming engine to the network outage.

The selectively suspending step can include prompting an end user whether to terminate the real time data exchange, or whether to suspend the real time data exchange. Responsive to a selection by the end user to suspend the real time data exchange, the real time data exchange can be suspended albeit not terminated. The resuming step, in turn, can include determining whether the network outage has occurred remotely or locally. If it is determined that the network outage has occurred locally, polling can be performed to determine when the network outage has been alleviated locally. Otherwise, the method can include waiting for the network outage to become alleviated remotely. In either case, the real time data exchange can resume when the network outage condition has been alleviated.

A real time data exchange system configured to selectively suspend a real time data exchange responsive to network outages can include a real time streaming engine configured for coupling to a communicative linkage over which real time data is received for processing in a real time data processing application. The system also can include a real time data processing application communicatively linked to the real time streaming engine. Finally, the system can include prompting logic coupled to the real time data processing application and programmed to selectively choose to suspend or terminate an exchange of real time data such as speech data responsive to receiving an alert for a network outage in the communicative linkage.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a real time data exchange system configured for selective pausing over an unreliable network connection; and,

FIG. 2 is a flow chart illustrating a process for selectively pausing an exchange of real time data when detecting an unreliable network connection.

### DETAILED DESCRIPTION OF THE PREFERRED EMBODIMENTS

The present invention is a method, system and apparatus for selectively pausing an exchange of real time data when detecting an unreliable network connection. In accordance with the present invention, an unreliable connection can be detected as between two host platforms exchanging real time data over a computer communications network. The real time data can be speech data, as an example, and as yet a further example, the computer communications network can include one or more wireless communicative linkages. Responsive to the detection of an unreliable connection, the exchange of the real time data can be selectively suspended until a more reliable connection can be re-established.

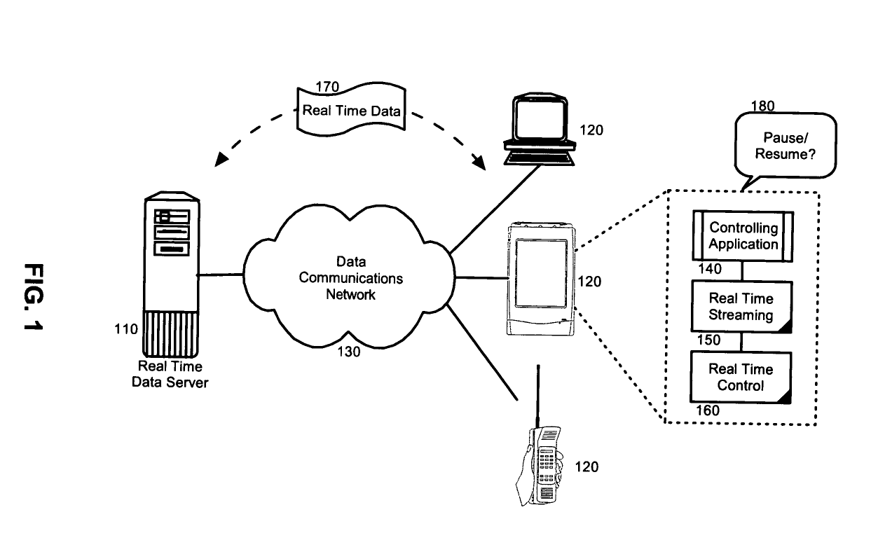

In further illustration of an aspect of the present invention, FIG. 1 is a schematic illustration of a real time data exchange system configured for selective pausing over an unreliable network connection. The system can include a real time data server 110 configured for communication with one or more client computing platforms 120 over a data communications network 130, part or all of which can include a computer communications network, and part or none of which can include a wire-bound or cellular telephone network. The client computing platforms 120 can range from desktop computing platforms to pervasive devices including data enabled cellular telephones and handheld personal digital assistants, to name only a few.

Notably, the real time data server 110 can stream real time data 170 to communicatively coupled ones of the client computing devices 120 over the data communications network 130. In this regard, the real time data 170 can be timing sensitive speech data and the real time data server can be a speech server. A controlling application 140 disposed within the client computing device 120 can manage the use and presentation of the real time data 170 received from the real time data server 110. An underlying real time streaming engine 150 cooperatively engaged with a real time transport control process 160, however, can manage the orderly receipt of the real time data 170. To that end, the real time data 170 can be exchanged between the real time data server 110 and real time streaming engine 150 using a real time data exchange protocol such as RTP over RTCP.

Importantly, the real time control process 160 can monitor the state and quality of the communicative linkage between the client computing device 120 and the real time data server 110. When the real time control process 160 detects a deterioration in quality, or a termination in its entirety of the communicative linkage, the real time control process 160 can notify the real time streaming engine 150, which in turn can notify the controlling application 140. Consequently, the controlling application 140 can issue a prompt 180 to the end user to suspend the exchange of the real time data 170 pending a re-establishment or improvement of the communicative linkage.

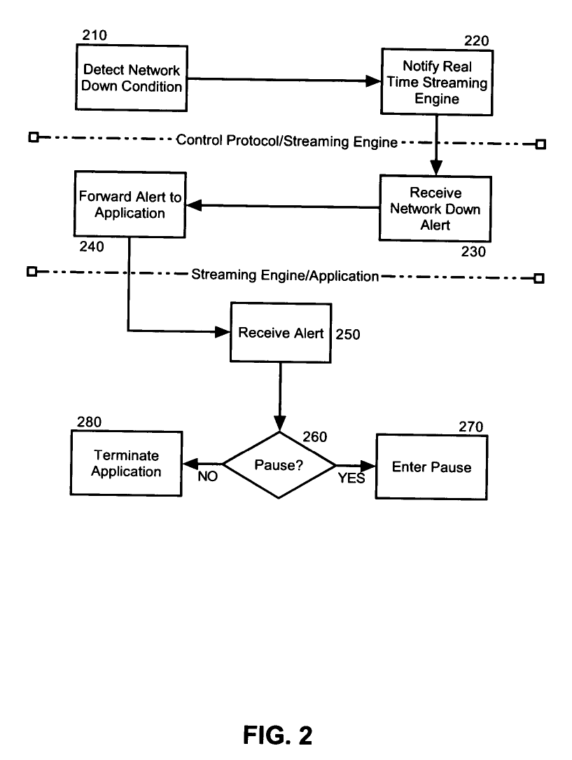

In more particular illustration, FIG. 2 is a flow chart depicting a process for selectively pausing an exchange of real time data when detecting an unreliable network connection. The flow chart shows three distinct portions of the process which preferably are handled in different portions of the client computing device—namely the control protocol, the real time streaming engine and the application. Notwithstanding, the invention is not limited to the precise arrangement shown and the entirety of the process or any portion thereof can be handled within any segment of the architecture of the client computing device.

Referring now to FIG. 2, beginning in block 210, a network outage or substantially declined communicative linkage can be detected as between the client and server in an exchange of real time data. Subsequently, in block 220 the real time streaming engine can be notified. In block 230 the “alert” can be received and in block 240, the alert can be forwarded to the application. In block 250 the alert can be received for processing in the application and in decision block 260 it can be determined whether or not to suspend the exchange of real time data.

If it is determined not to suspend the exchange, in block 280 the exchange can be terminated. Otherwise, in block 270 the exchange of data can be suspended until the communicative linkage can be restored. In this regard, to the extent that the network outage is determined to be local in nature, the real time streaming engine can poll the network periodically to determine when a communicative linkage has been restored. In contrast, to the extent that the network outage is determined to be remote in nature, the real time streaming engine simply can await the receive of the next audio packet which will be presumed to occur when the communicative linkage has been restored. Of course, when the communicative linkage is restored, set up parameters, such as port data may be required to be exchanged prior to a continuation of an exchange of real time data.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. A real time data exchange suspension method comprising the steps of:
detecting a network outage condition affecting a real time data exchange;
selectively suspending but not terminating said real time data exchange; and,
resuming said real time data exchange when said network outage condition has been alleviated.

2. The method of claim 1, wherein said detecting step comprises the step of detecting a loss of a communicative linkage with a real time data server supporting said real time data exchange.

3. The method of claim 1, wherein said detecting step comprises the step of detecting a severe deterioration in link quality of a communicative linkage with a real time data server supporting said real time data exchange.

4. The method of claim 1, wherein said detecting step comprises the steps of:
monitoring a communicative linkage over which said real time data exchange occurs;
observing a network outage in said communicative linkage; and,
alerting a real time streaming engine to said network outage.

5. The method of claim 1, wherein said selectively suspending step comprises the steps of:
prompting an end user whether to terminate said real time data exchange, or whether to suspend said real time data exchange; and,
responsive to a selection by said end user to suspend said real time data exchange, suspending but not terminating said real time data exchange.

6. The method of claim 1, wherein said resuming step comprises the steps of:
determining whether said network outage has occurred remotely or locally;
if it is determined that said network outage has occurred locally, performing polling to determine when said network outage has been alleviated locally;
if it is determined that said network outage has occurred remotely, waiting for said network outage to become alleviated remotely; and,
resuming said real time data exchange when said network outage condition has been alleviated.

7. The method of claim 1, wherein said real time data exchange is an exchange of speech data provided by a real time speech server over a data communications network.

8. A real time data exchange system configured to selectively suspend a real time data exchange responsive to network outages, the system comprising:
a real time streaming engine configured for coupling to a communicative linkage over which real time data is received for processing in a real time data processing application;
a real time data processing application communicatively linked to said real time streaming engine; and,
prompting logic coupled to said real time data processing application and programmed to selectively choose to suspend or terminate an exchange of real time data responsive to receiving an alert for a network outage in said communicative linkage.

9. The system of claim 8, wherein said real time data is speech data.

10. The system of claim 8, wherein said real time streaming engine implements logic for managing real time protocol (RTP) formatted data over an real time protocol control (RTPC) protocol.

11. A machine readable storage having stored thereon a computer program real time data exchange suspension, the computer program comprising a routine set of instructions which when executed by a machine causes the machine to perform the steps of:
detecting a network outage condition affecting a real time data exchange;
selectively suspending but not terminating said real time data exchange; and,
resuming said real time data exchange when said network outage condition has been alleviated.

12. The machine readable storage of claim 11, wherein said detecting step comprises the step of detecting a loss of a communicative linkage with a real time data server supporting said real time data exchange.

13. The machine readable storage of claim 11, wherein said detecting step comprises the step of detecting a severe deterioration in link quality of a communicative linkage with a real time data server supporting said real time data exchange.

14. The machine readable storage of claim 11, wherein said detecting step comprises the steps of:
monitoring a communicative linkage over which said real time data exchange occurs;
observing a network outage in said communicative linkage; and,
alerting a real time streaming engine to said network outage.

15. The machine readable storage of claim 11, wherein said selectively suspending step comprises the steps of:
prompting an end user whether to terminate said real time data exchange, or whether to suspend said real time data exchange; and,
responsive to a selection by said end user to suspend said real time data exchange, suspending but not terminating said real time data exchange.

16. The machine readable storage of claim 11, wherein said resuming step comprises the steps of:
determining whether said network outage has occurred remotely or locally;
if it is determined that said network outage has occurred locally, performing polling to determine when said network outage has been alleviated locally;
if it is determined that said network outage has occurred remotely, waiting for said network outage to become alleviated remotely; and,
resuming said real time data exchange when said network outage condition has been alleviated.

17. The machine readable storage of claim 11, wherein said real time data exchange is an exchange of speech data provided by a real time speech server over a data communications network.
